(19) United States
(12) Patent Application Publication
(10) Pub. No.: US 2007/0048411 A1
(43) Pub. Date: Mar. 1, 2007

(54) Combined confection and beverage product

(75) Inventors: Stephen Boom, BL Delft (NL); Vera Brands, BL Delft (NL); Jeroen Harthoorn, BL Delft (NL); Marie Claire van der Lande, JL Rotterdam (NL); Helma van Rijn, BL Delft (NL); Abbie Vanhoutte, BL Delft (NL); Remko Verhaagen, BL Delft (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/510,466

(22) Filed: Aug. 25, 2006

(30) Foreign Application Priority Data
Aug. 26, 2005 (EP) EP05255263

(51) Int. Cl. A21D 10/02

(52) U.S. Cl. 426/112

(57) ABSTRACT

A combined confection and beverage product comprising a drink receptacle comprising (i) a first compartment which contains a beverage; (ii) a second compartment which is elevated with respect to at least a portion of the first compartment and which contains a meltable confection; (iii) a partition which separates the first and second compartments and which comprises one or more apertures; characterised in that the first compartment comprises a drinking orifice.

### TECHNICAL FIELD OF THE INVENTION

The present invention relates to a combined confection and beverage product. In particular, it relates to a product comprising a receptacle with two or more compartments, one compartment containing a beverage, such as coffee, and another containing a meltable confection, such as ice cream.

### BACKGROUND

Ice cream floats are popular products that combine a beverage, such as a carbonated soft drink, with a confection, such as ice cream. The ice cream is placed on top of the beverage. Since the beverage is warmer than the ice cream, the ice cream melts and mingles with the beverage to produce a pleasant foamy and syrupy mixture. Iced coffee is a similar type of product in which cold coffee is combined with crushed ice, and optionally, cream, syrup, chocolate sprinkles, etc. to provide a refreshing product. However, ice cream floats can be messy and are not very portable.

Attempts have been made to address these issues. U.S. Pat. No. 2,975,925 discloses a container attachment for beverage bottles into which an edible material such as ice cream is placed. When the container is attached to a bottle and the bottle is raised in the act of drinking, the beverage will pass through the container and be mixed with or flavoured by the ice cream. Various modifications to this type of container are disclosed in U.S. Pat. No. 5,085,330, U.S. Pat. No. 6,776,315, US 2004/0253351 and US 2004/0256401. GB 2,259,241 and U.S. Pat. No. 5,312,014 describe similar containers specifically adapted for attachment to beverage cans. The latter container can also be attached to a mug. U.S. Pat. No. 4,478,346 discloses an insert cup for holding ice in a beverage container. The insert cup has openings to allow the beverage to pass through and be cooled by the ice during drinking. U.S. Pat. No. 6,502,715 discloses a drinking receptacle which functions either to dispense liquids or to be capable of supporting a frozen food product, but does not consider combined products.

A further aspect of the problem is that ice cream floats and similar products are time consuming to prepare since the beverage and confection must be added separately. This is particularly inconvenient in ice cream parlours and fast food restaurants where customers expect quick service. Therefore, there remains a need for improved combined confection and beverage products, and methods for providing them.

Definitions

Unless defined otherwise, all technical and scientific terms used herein have the same meaning as commonly understood by one of ordinary skill in the art.

Meltable Confection

The term meltable confection as used herein means a solid or semi-solid foodstuff which at least partially melts or liquefies when warmed up, either by the beverage or by the environment (which is typically in the temperature range of 5 to 35° C., e.g. room temperature of ca. 18° C.). Meltable confections accordingly include frozen confections such as ice cream (including soft ice cream), water ice, frozen yoghurt and the like, ice cubes, crushed ice, etc.; sweet confections such as chocolate, caramel and the like; and savoury confections such as cheese, butter, sour cream, mayonnaise and the like.

Beverage

The term beverages includes hot beverages, for example tea, coffee, hot chocolate and soup; and also cold beverages, such as carbonated drinks, lemonade, cola, iced tea, iced coffee, fruit juice, and the like. The term beverage does not include the melted confection per se.

Drinking Orifice

The term drinking orifice means an orifice through which liquid passes to the consumers mouth. Thus when it is stated that a compartment comprises a drinking orifice it is meant that the orifice permits liquid to pass from that compartment directly to the mouth. An orifice which permits liquid to pass from a first compartment to a second compartment and thence to the mouth via another orifice does not constitute a drinking orifice as defined herein.

### BRIEF DESCRIPTION OF THE INVENTION

We have developed a combined confection and beverage product that is suitable for a wide range of confection and beverage combinations. Accordingly, in a first aspect the present invention provides a combined confection and beverage product comprising a drink receptacle comprising
(i) a first compartment which contains a beverage;
(ii) a second compartment which is elevated with respect to at least a portion of the first compartment and which contains a meltable confection;
(iii) a partition which separates the first and second compartments and which comprises one or more apertures;
   characterised in that the first compartment comprises a drinking orifice.

In use melted confection can pass from the second compartment to the first compartment via the one or more apertures. The product has a drinking orifice in the compartment containing the beverage so that the beverage can pass directly from the first compartment to the consumer's mouth, without passing through the second compartment. Thus unlike the previous containers, for example as disclosed in U.S. Pat. No. 5,312,014, it is not necessary for the beverage to pass through the compartment that contains the confection in the act of drinking. We have found that this avoids very rapid melting of the confection when a hot beverage is used. The partition between the second and first compartments keeps the meltable confection and the beverage separate, preventing rapid melting and maintaining the desirable temperature and texture contrast between the confection and the beverage, even when the beverage is hot. The aperture(s) allow the melted confection to mix gradually with the beverage, so that over time, their flavours mix and the taste of the beverage slowly transforms.

Preferably the second compartment is not enclosed. This allows the confection to be consumed separately from the beverage in addition to being consumed after having melted and mixed with the beverage.

The drink receptacle may consist of a single article, or may comprise separable articles. In one embodiment the receptacle comprises a cup and a lid wherein at least a portion of the second compartment is integral to the lid. Preferably the lid comprises a depression which at least partially defines the second compartment.

Preferably the lid at least partially defines the drinking orifice.

Preferably the lid engages detachably with the cup.

Preferably the lid can be stacked with other lids and the cups can be stacked with other cups.

Preferably at least one of the one or more apertures in the partition is located at the bottom of the second compartment. More preferably, a further aperture is located at the side of the second compartment closest to the drinking orifice, such that when the cup is upright, the further aperture is above the surface of the beverage.

Preferably the confection is a frozen confection. More preferably, the frozen confection is ice cream.

Preferably the beverage is a hot beverage. Most preferably the beverage is selected from the group consisting of coffee, tea and hot chocolate.

Preferably the volume of the confection is from 10 to 500 ml, most preferably from 20 to 200 ml.

Preferably the volume of the beverage is from 50 to 1000 ml, most preferably from 100 to 500 ml.

We have developed a method for preparing combined confection and beverage product that is suitable for use in fast food restaurants and similar outlets. Accordingly, in a second aspect the present invention provides a method for preparing a combined confection and beverage, the method comprising:
(a) providing a drink receptacle comprising
   (i) a first compartment comprising a drinking orifice;
   (ii) a second compartment which is elevated with respect to at least a portion of the first compartment and which contains a meltable confection;
   (iii) a partition which separates the first and second compartments and which comprises one or more apertures;
(b) introducing a beverage into the first compartment.

Preferably between steps (a) and (b), the drink receptacle is transported to the point of use under conditions such that the meltable confection does not melt.

The invention also provides a pack suitable for use in the present method, which pack contains one or more drink receptacles comprising
(i) a first compartment comprising a drinking orifice;
(ii) a second compartment which is elevated with respect to at least a portion of the first compartment and which contains a meltable confection;
(iii) a partition which separates the first and second compartments and which comprises one or more apertures.

### DETAILED DESCRIPTION

The present invention will now be further described by reference to the drawings, wherein;

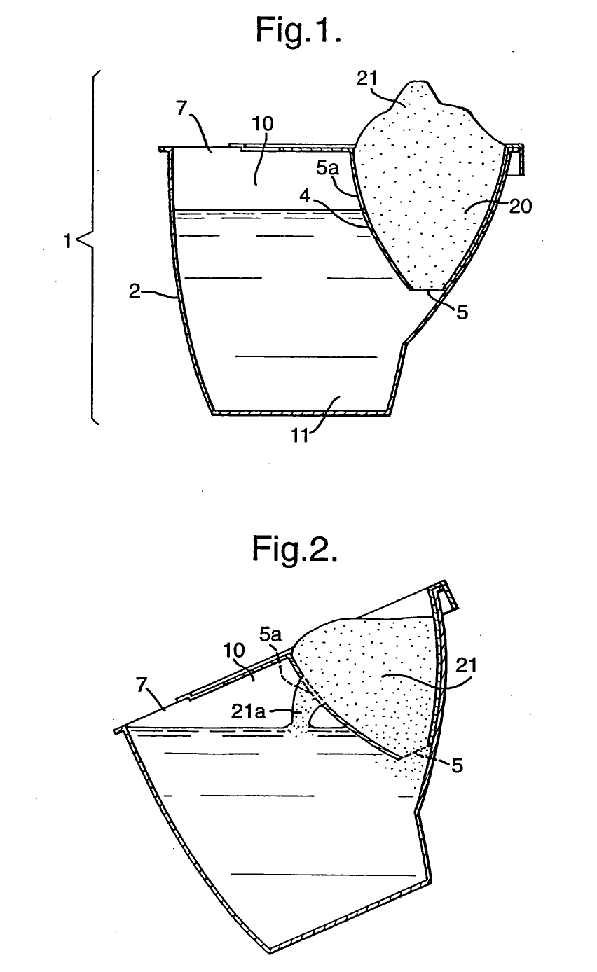

FIG. 1 is a schematic view of a combined confection and beverage product according to the invention.

FIG. 2 shows the product of FIG. 1 when tilted in the act of drinking.

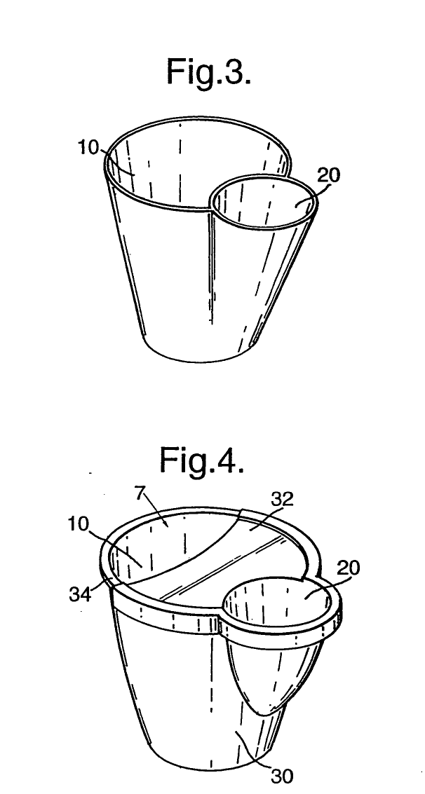

FIG. 3 shows a perspective view of an embodiment of a receptacle in which the first compartment and the second compartment are formed as a single article.

FIG. 4 shows in perspective an embodiment of a receptacle comprising a cup and a lid.

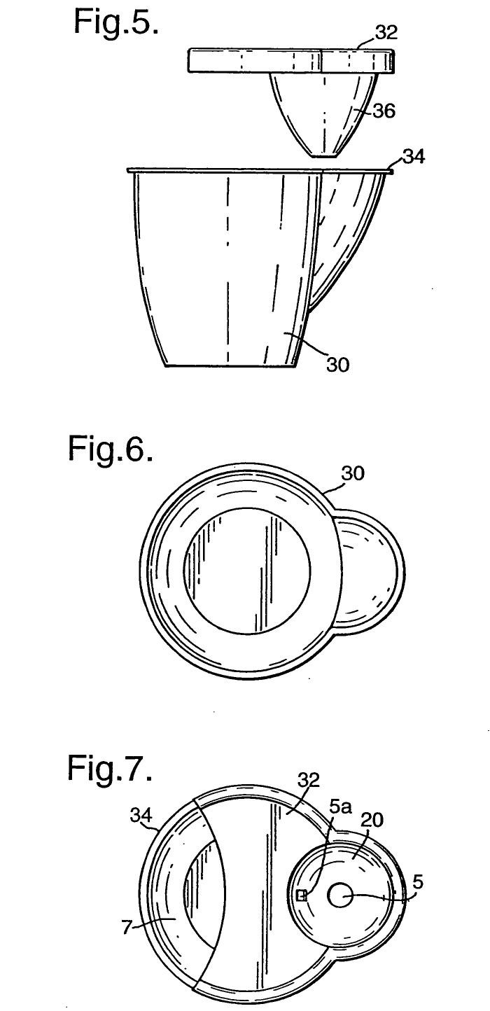

FIG. 5 is a side view of the embodiment of FIG. 4 showing the lid and cup when separated.

FIG. 6 is a top view of the cup of FIG. 4 when the lid is not present.

FIG. 7 is a top view of the receptacle of FIG. 4 when the lid is present.

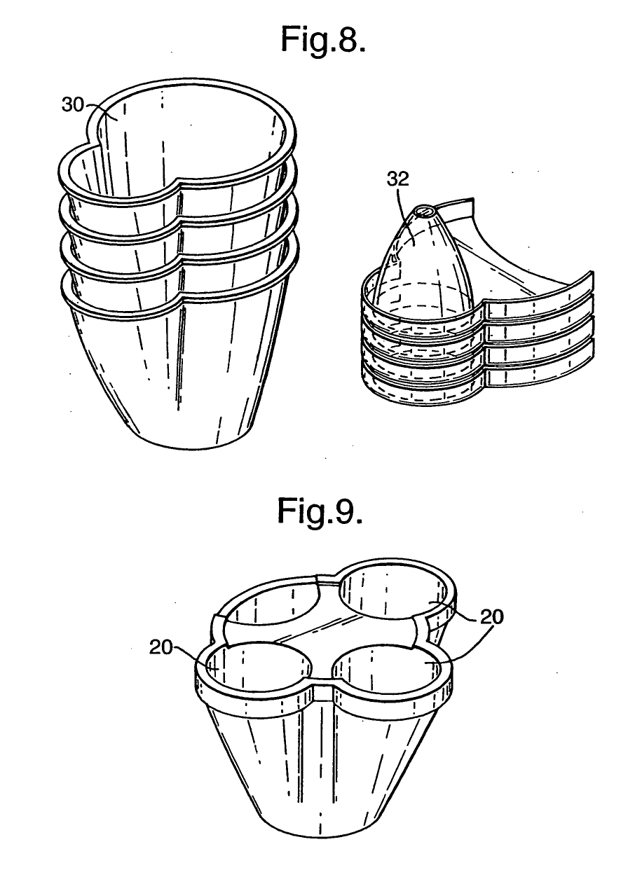

FIG. 8 shows lids and cups of FIG. 4 separately stacked for storage.

FIG. 9 shows a receptacle having a plurality of second compartments.

FIG. 1 shows a combined confection and beverage product 1 comprising a drink receptacle 2 comprising a first compartment 10 and a second compartment 20. A partition 4 separates the first compartment 10 and the second compartment 20. The partition 4 contains one or more apertures 5. The first compartment 10 has a drinking orifice 7 and contains a beverage 11. The second compartment 20 contains a meltable confection 21. The second compartment 20 is elevated with respect to at least a portion of the first compartment 10 so that in use melted confection 21 can pass from the second compartment 20 to the first compartment 10 via the aperture(s) 5 and mix with the beverage 11. Preferably at least one of the one or more apertures 5 in the partition 4 is located at the bottom of the second compartment 20. More preferably, a further aperture 5a is located at the side of the second compartment closest to the drinking orifice, such that when the cup is upright, the further aperture 5a is above the surface of the beverage. When the second compartment 20 is not enclosed, some of the confection may also be consumed without mixing with the beverage, thus providing an interesting texture and/or temperature and/or flavour contrast.

The beverage 11 can be a hot beverage, for example tea, coffee, hot chocolate, or soup, or a cold beverage, such as a carbonated drink, lemonade, cola, iced tea, iced coffee or fruit juice and the like. The meltable confection 21 is a solid or semi-solid confection which at least partially melts or liquifies when warmed up, either by the beverage or by the environment. The meltable confection can be a frozen confection such as ice cream, water ice, frozen yoghurt and the like, ice cubes, crushed ice or a sweet confection such as chocolate, caramel, and the like. The confection may also be savoury, for example cheese, butter, sour cream, mayonnaise and the like. Savoury confections are typically combined with savoury beverages, such as soup. It should be understood that when the confection is not meltable at room temperature it must be combined with a hot beverage (i.e. a beverage at a temperature sufficiently high to warm the confection and cause it to melt). Thus chocolate should be combined with a hot beverage, such as coffee, cheese with hot soup, and so on, whereas frozen confections may be combined with hot or cold drinks. A combined ice cream and coffee or ice cream and hot chocolate product provides a particularly pleasant and contrasting sensory experience. Soft ice cream, i.e. ice cream which is served straight from an soft-serve ice cream freezer, typically at a temperature of between −10 and −3° C. is particularly suitable as it can be easily dispensed into the second compartment. Ice cream may also be dispensed from a cartridge (as described for example in EP A 1 459 634) or simply scooped from a tub kept in a storage freezer, typically at −18° C. The volume of the confection is typically from 10 to 500 ml and the volume of the beverage is typically from 50 to 1000 ml. These volumes provide a suitably sized serving.

When the combined product consists of a hot beverage and a frozen confection, it is desirable to serve the beverage at a hotter temperature than the temperature at which the beverage alone would be served, because of the cooling effect of the frozen confection. For example, 65° C. is a suitable temperature for serving a hot beverage such as coffee. However, when a combined coffee and ice cream product according to the invention is served, the coffee should be at a higher temperature, for example 75° C., so that when it is cooled down by the melted ice cream it reaches a suitable drinking temperature. If the coffee were served at the usual serving temperature, it would become cold too rapidly.

The beverage 11 may be consumed by tilting the cup as shown in FIG. 2 and drinking directly from the first compartment 10, in which case the drinking orifice 7 is typically an open section of the top of the receptacle. When the cup is tilted towards the drinking orifice as the beverage is drunk, melted confection 21a can flow through the aperture 5a into the first compartment as shown. The aperture 5a prevents melted confection from overflowing the top of the second compartment as the cup is tilted and further allows melted confection to mix into the beverage. The drinking orifice 7 may also accommodate a straw through which the beverage can be consumed.

The aperture(s) 5 must be sufficiently small to prevent solid or semi-solid confection from falling into the beverage 11 in the first compartment 10, but must not so small that melted confection only passes through very slowly. Preferably the aperture(s) have areas between 0.03 cm² and 30 cm², more preferably between 0.13 cm² and 13 cm², for example the apertures are circular with a diameter of between 1 mm and 3 cm, more preferably between 2 mm and 2 cm. The rate of melt of the confection, the viscosity of the melted confection and the aperture size affect the rate at which the melted confection mixes into the beverage. The rate of mixing can be increased by stirring the beverage, for example with a spoon, stirrer or straw via the drinking orifice 7.

The receptacle may be made from any suitable material. Preferably the cup is made from a material with good thermal insulation, so that heat flow between the beverage and the external environment is minimised. Thus hot beverages stay hot, and cold beverages stay cold for longer.

FIG. 3 shows a perspective view of an embodiment of a receptacle 2 in which the first compartment 10 and the second compartment 20 are formed as a single article.

FIG. 4 shows a perspective view of a second embodiment of a receptacle 2 which comprises a cup 30 which houses the first compartment 10 and a lid 32 which defines the second compartment 20. The lid 32 is detachable from the cup 30, and engages with the upper rim 34 of the cup to form a seal. The lid 32 does not completely cover the top of the cup 30, but leaves open a drinking orifice 7. FIG. 5 is a side view of the receptacle of FIG. 4 showing the cup 30 and lid 32 when separated. The second compartment is defined by a depression in the lid 36. FIG. 6 is a top view of the cup 30 of FIG. 4 without the lid. FIG. 7 is a top view of the receptacle of FIG. 4 when the lid 32 is engaged with upper rim 34 of the cup 30. The aperture(s) 5 is situated at the bottom of the depression 34 in the lid 32 which defines the second compartment 20. The further aperture 5a is located at the side of the second compartment closest to the drinking orifice 7. Attaching a lid that at least partially defines the second compartment and the drinking orifice to a suitable cup is a simple and economical means of forming the receptacle. The lids 32 and cups 30 of the embodiment of FIG. 4 may be stackable with other such lids and cups respectively for convenient storage as shown in FIG. 8. In FIG. 8 the stacked lids are inverted i.e. the underside of the lid is uppermost, so that the stack has a flat base.

In the embodiments shown in FIG. 3 and FIGS. 4-8, the second compartment (when viewed from above) extends outside the perimeter of the first compartment. It is also possible that the second compartment is entirely within the perimeter of the first compartment. So, for example, the receptacle (when viewed from above) has a circular perimeter. Thus for example a conventional beverage cup (i.e. having a circular cross-section) could be used with a circular lid comprising a second compartment. This has the advantage that only the lids need be specially provided.

The receptacle 2 may comprise more than one second compartment 20 as shown in FIG. 9. The second compartments are separated from the first compartment by partitions, each of which contains at least one aperture. Different meltable confections may be placed into the second compartments in order to provide a greater range of textures, temperatures and flavours. For example a product may consist of coffee in the first compartment with ice cream in one second compartment and caramel in another second compartment. Both of the confections are able to mix with the beverage. The first compartment and the second compartment may be formed as a single article (as for the embodiment shown in FIG. 3). Alternatively, they may be defined by depressions in a detachable lid (as for the embodiment shown in FIGS. 4 to 8).

Packs containing one or more drink receptacles whose second compartments contain a meltable confection can be prepared and packed in a food factory with well-developed quality assurance methods. The packs are stored and transported to the point of use, e.g. a fast food restaurant, under conditions such that the meltable confection does not melt (for example under chilled or frozen conditions). To prepare a combined confection and beverage product for consumption, the personnel at the point of use only need to take the drink receptacle whose second compartment contains a meltable confection from the pack and then add the beverage from a beverage dispenser. This method is much faster than the conventional process of taking a cup or glass, filling with beverage, then removing the confection from e.g. the fridge or freezer, portioning the confection and finally adding the portion to the beverage. It also is more hygienic and allows better portion control.

The choice of packaging material is not critical and a wide range of materials is available, for example, plastic containers or cardboard boxes. The packaging material can be chosen depending on transport and storage conditions. Depending on the nature of the meltable confection, the drink receptacles can be stored at ambient temperature or chilled, preferably at a temperature of 2-8° C. However it is preferred that they are stored frozen, preferably at a temperature of −4 to −30° C., more preferably at −8 to −24° C. Suitably the packing is done such that individual drink receptacles can easily be taken from the pack without necessarily removing the whole pack from the store (e.g. the fridge or freezer).

The present invention will now be further described with reference to the following examples, which are illustrative only and non-limiting.

### EXAMPLES

### Example 1

### Hot Coffee and Ice Cream

Approximately 200 ml of hot coffee (at 75° C.) was placed in the first (lower) compartment of a receptacle as shown in FIG. 3. The coffee filled the first compartment up to the level of the bottom of the second compartment. Approximately 100 ml of soft ice cream (at about −5° C.) was then placed in the second (upper) compartment to produce a combined product according to the invention. The base of the second compartment had a circular aperture with diameter of 1 cm. The ice cream was observed to melt slowly, forming a layer of melted ice cream at the bottom of the second compartment, on top of which floated the remaining frozen ice cream. The melted ice cream passed through the aperture and gradually mixed into the coffee, so that it turned from a dark brown colour to a lighter brown. Coffee did not visibly pass into the upper compartment. After 10 minutes, the ice cream had still not completely melted. The product was then tasted via the drinking orifice and found to be a creamy coffee beverage which became noticeably more creamy with time. Cold ice cream was consumed from the second compartment with a spoon. The combination of hot creamy coffee and contrasting cold ice cream produced a pleasant and contrasting sensory experience.

### Example 2

### Hot Chocolate and Ice Cream

Example 1 was repeated, but using hot chocolate instead of coffee. A creamy chocolate beverage resulted. Again, some ice cream remained unmelted after 10 minutes, so that the contrast between hot beverage and cold ice cream was observed, whilst the beverage became gradually more creamy as the ice cream melted.

### Example 3

### Hot Coffee and Ice Cream with Stirring

Example 1 was repeated, but this time the coffee was stirred. A similar creamy beverage resulted. The ice cream was observed to melt faster than without stirring.

The above examples demonstrate a combined confection and beverage product according to the invention. The invention avoids the necessity for the beverage to pass through the compartment that contains the confection, so that the temperature and texture contrast between the confection and beverage is maintained. Nonetheless, the melted confection mixes gradually with the beverage, so that over time, the flavours combine and the taste of the beverage slowly transforms. The rate of melting of the confection can be increased if desired by stirring the beverage. The product also allows for separate consumption of the confection, thereby providing an interesting sensory experience. The combined confection and beverage product is suitable for a wide range of confection and beverage combinations.

The various features of the embodiments of the present invention referred to in individual sections above apply, as appropriate, to other sections mutatis mutandis. Consequently features specified in one section may be combined with features specified in other sections as appropriate.

All publications mentioned in the above specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

1. A combined confection and beverage product comprising a drink receptacle comprising
(i) a first compartment which contains a beverage;
(ii) a second compartment which is elevated with respect to at least a portion of the first compartment and which contains a meltable confection;
(iii) a partition which separates the first and second compartments and which comprises one or more apertures;
characterised in that the first compartment comprises a drinking orifice.

2. A product according to claim 1 wherein the second compartment is not enclosed.

3. A product according to claim 1 wherein the receptacle comprises a cup and a lid wherein at least a portion of the second compartment is integral to the lid.

4. A product according to claim 3 wherein the lid comprises a depression which at least partially defines the second compartment.

5. A product according to claim 3 wherein the lid at least partially defines the drinking orifice.

6. A product according to claim 3 wherein the lid engages detachably with the cup.

7. A product according to claim 6 wherein the lid can be stacked with other lids and the cups can be stacked with other cups.

8. A product according to claim 1 wherein at least one of the one or more apertures in the partition is located at the bottom of the second compartment.

9. A product according to claim 8 wherein a further aperture is located at the side of the second compartment closest to the drinking orifice, such that when the cup is upright, the further aperture is above the surface of the beverage.

10. A product according to claim 1 wherein the confection is a frozen confection.

11. A product according to claim 1 wherein the beverage is a hot beverage selected from the group consisting of coffee, tea and hot chocolate.

12. A product according to claim 1 wherein the volume of the confection is from 10 to 500 ml.

13. A product according to claim 1 wherein the volume of the beverage is from 50 to 1000 ml

14. A method for preparing a combined confection and beverage product, the method comprising:
(a) providing a drink receptacle comprising
(i) a first compartment comprising a drinking orifice;
(ii) a second compartment which is elevated with respect to at least a portion of the first compartment and which contains a meltable confection;
(iii) a partition which separates the first and second compartments and which comprises one or more apertures;
(b) introducing a beverage into the first compartment.

15. A method according to claim 14 wherein between steps (a) and (b), the drink receptacle is transported to a point of use under conditions such that the meltable confection does not melt.

16. A method according to claim 14 wherein the meltable confection is a frozen confection.

17. A pack suitable for use in the method of claim 14 which pack contains one or more drink receptacles comprising
(i) a first compartment comprising a drinking orifice;
(ii) a second compartment which is elevated with respect to at least a portion of the first compartment and which contains a meltable confection;
(iii) a partition which separates the first and second compartments and which comprises one or more apertures;

18. A pack according to claim 17 wherein the meltable confection is a frozen confection.
